(19) United States
(12) Patent Application Publication
(10) Pub. No.: US 2003/0035449 A1
(43) Pub. Date: Feb. 20, 2003

(54) Laser systems

(76) Inventors: Andrew Tomlinson, Oxford (GB); Jolyon Tidmarsh, Oxford (GB)

Correspondence Address: Mark D. Saralino, Nineteenth Floor, 1621 Euclid Avenue, Cleveland, OH, 44115-2191, US

(21) Appl. No.: 10/218,237

(22) Filed: Aug. 14, 2002

(30) Foreign Application Priority Data
Aug. 16, 2001 (GB) 0119974.4

(51) Int. Cl. H01S 3/13; G02B 6/26; G02F 1/01

(52) U.S. Cl. 372/29.02; 385/15; 359/279

(57) ABSTRACT

An external cavity laser system comprises a reflective optical amplifier 3, an input waveguide 4 for receiving an optical input signal from the reflective optical amplifier 3, a Bragg grating 5 for reflecting a portion of the optical input signal back along the input waveguide 4 to define a resonant cavity with the optical amplifier, and a reflection photodiode 30 for detecting the signal portion reflected by the grating 5 and for supplying an electrical feedback signal indicative of the signal portion. A transmission photodiode 6 is also provided for detecting the signal portion transmitted by the grating 5 and for supplying an electrical feedback signal indicative of that signal portion. These feedback signals are supplied to a control circuit which controls a phase modulator to modulate the phase of the optical input signal so as to ensure zero detuning between the dominant signal mode and the peak of the grating. This ensures that a stabilised optical output signal is provided at the output of the system which is unaffected by changes in the laser drive current and which is not subject to mode hops.

The present invention relates to laser systems.

In the field of optical communications, optical transmitters which transmit a number of distinct wavelengths or frequencies have limited range because the different frequencies travel at different speeds in optical fibres. This effect, referred to as chromatic dispersion, provides one of the limits to the maximum span of a optical link. Special single frequency lasers such as Distributed Bragg Reflector (DBR) lasers or Distributed Feedback (DFB) lasers are therefore preferred in communication systems with longer links as they dramatically reduce the dispersion limit in the optical network.

Distributed Bragg reflection (DBR) lasers are external cavity lasers having a DBR mirror which can be used as single frequency laser transmitters. However, it is difficult to guarantee that a DBR laser operates on a single cavity mode, since often two longitudinal cavity modes compete and degrade the transmitted optical signal. Therefore DFB lasers, which when well-designed do not suffer form this problem, are often used in preference to DBRs. In a typical device the output power of such a laser is monitored by a monitor photodiode. The output from the photodiode can be used to provide an electrical feedback signal which can be used, in conjunction with means to vary the optical length of the cavity, to effect mode control. Such a control method is disclosed in “Simple Spectral Control Technique for External Cavity Laser Transmitters”, K. R. Preston, Electronics Letters, Vol. 18, No. 25, December 1982. Alternative mode control methods are described in “Continuously-tunable Single-frequency Semiconductor Lasers”, L. A. Coldren and S. W. Corzine, IEEE Journal of Quantum Electronics, Vol. QE-23, No. 6, June 1987, and “Wavelength and Mode Stabilisation of Widely Tunable SG-DBR and SSG-DBR Lasers”, G. Sarlet et al., IEEE Photonics Technology Letters, Vol. 11, No. 11, November 1999. Furthermore a method for mode control of a gas laser is disclosed in “Frequency Stabilisation of Gas Lasers”, A. D. White, IEEE Journal of Quantum Electronics, Vol. QE-1, No. 8, November 1965.

However such known control methods do not always function well, as the shape of the control signal transfer characteristics changes with the laser drive current, and the characteristics can additionally be flat and noisy.

It is an object of the invention to provide a laser system which is capable of providing a stabilised output signal with high efficiency and which can be manufactured at low cost.

According to the present invention there is provided a laser system comprising an input waveguide for receiving an optical input signal from an optical amplifier, partial reflecting means for receiving the optical input signal from the input waveguide and for reflecting a portion of the optical input signal back along the input waveguide to define a resonant cavity with the optical amplifier, reflection photodetector means for detecting light reflected back by the partial reflecting means and for supplying an electrical output signal indicative of the reflected light, phase modulation means for modulating the phase of the optical input signal, and control means for controlling the phase modulation means in dependence on the electrical output signal from the reflection photodetector means in order to provide a stabilised optical output signal.

Highly efficient mode control can be provided by such a laser system due to the fact that the reflection transfer function will be substantially unaffected by changes in the laser drive current, and since the reflection transfer function will depend on the reflection characteristics of the reflection means which can be maintained unchanged. It should be appreciated that the reflection photodetector means for detecting light reflected back by the partial reflecting means may be a back facet photodetector for detecting light transmitted from the back facet of the optical amplifier, or alternatively may be a photodetector optically coupled to the input waveguide for directly detecting light reflected by the partial reflecting means.

In order that the invention may be more fully understood, embodiments of the invention will now be described, by way of example, with reference to the accompanying drawings, in which:

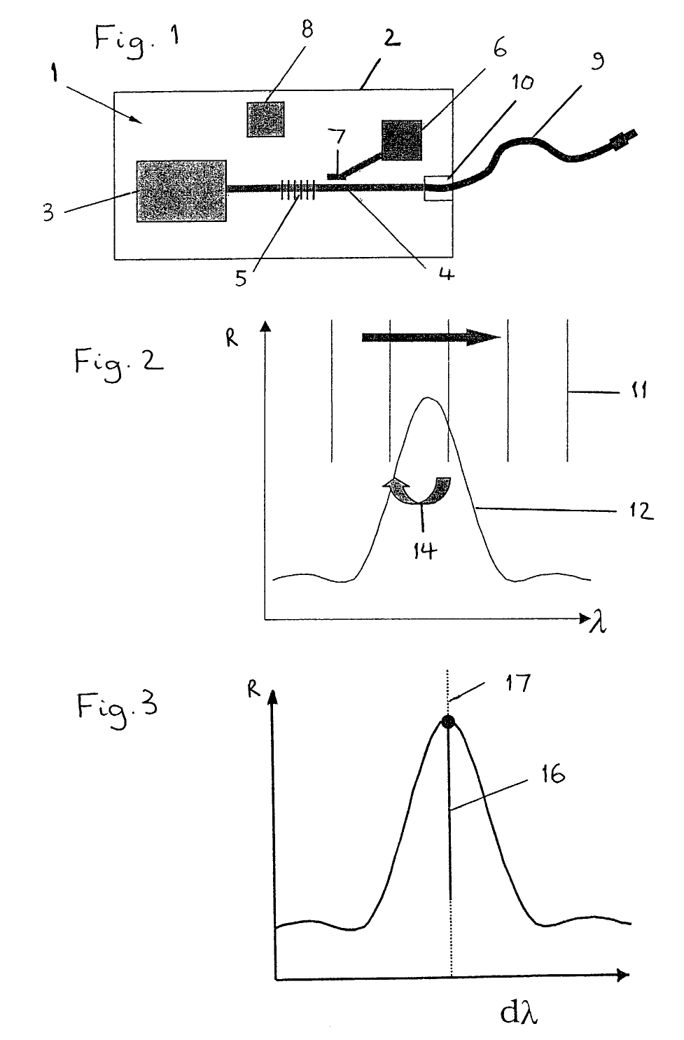

FIG. 1 is a block diagram of a known DBR laser;

FIG. 2 is a graph of reflected intensity against wavelength for a DBR mirror in isolation illustrating a mode hop between adjacent modes;

FIG. 3 is a graph showing the cavity mode aligned to the centre of the Bragg peak;

FIG. 4 is a diagram showing use of a phase modulator in such a laser;

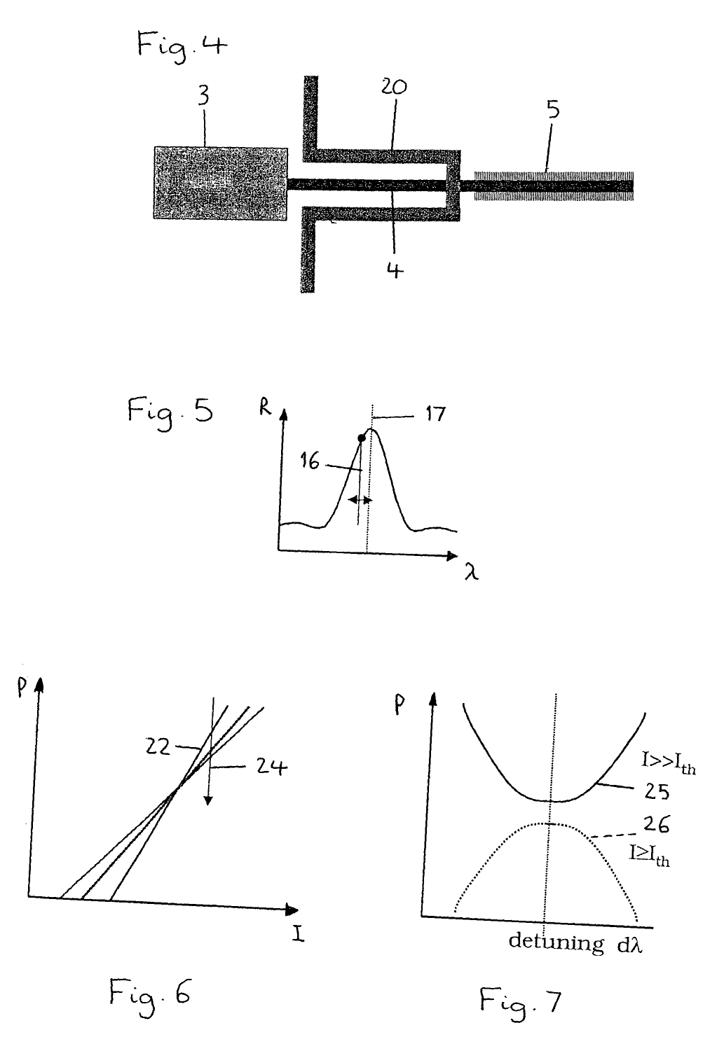

FIG. 5 is an explanatory graph;

FIGS. 6 and 7 are graphs showing the effect of detuning upon output power measured with constant current in the reflection amplifier;

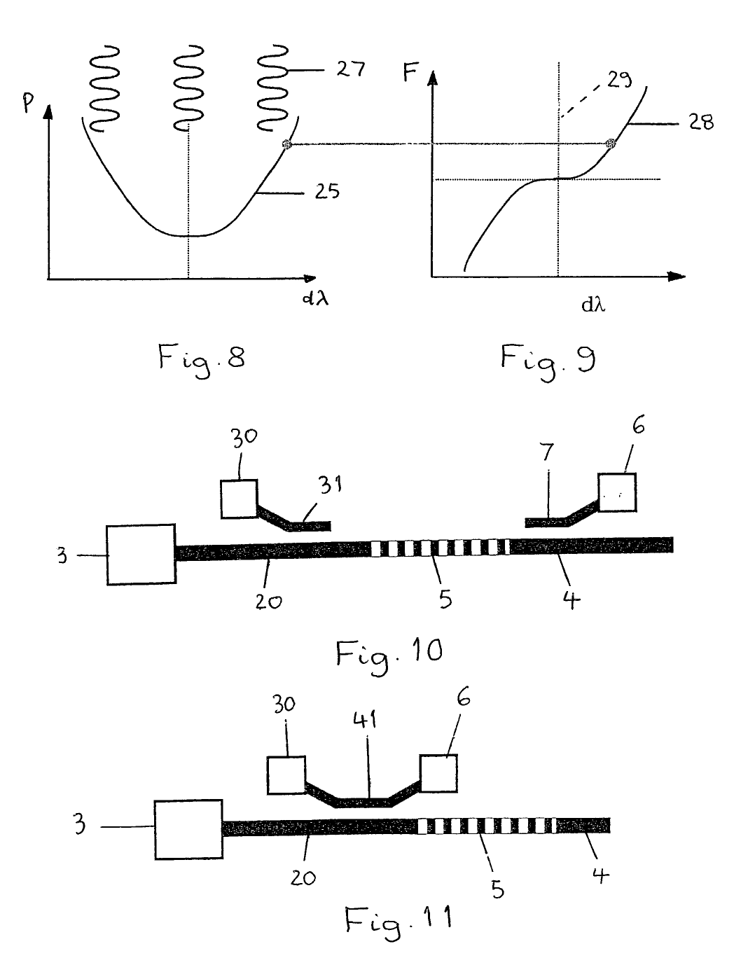

FIGS. 8 and 9 are graphs of the output power and first differential during detuning;

FIGS. 10 and 11 are diagrams showing two alternative embodiments of the invention; and

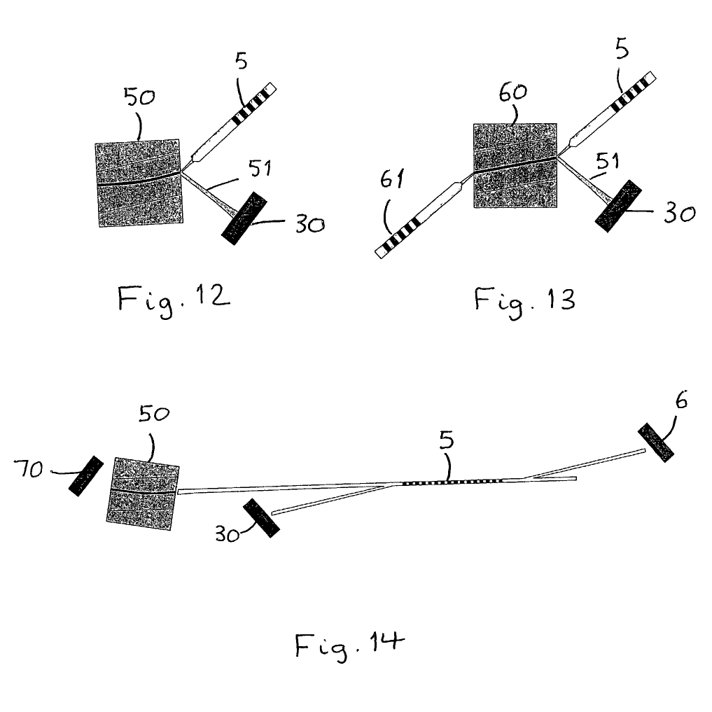

FIGS. 12, 13 and 14 are diagrams illustrating further embodiments of the invention.

The single channel hybrid DBR laser 1 shown in FIG. 1 is an external cavity laser capable of being used as a single frequency laser transmitter. The laser 1 comprises a SOI substrate 2, a reflective optical amplifier 3 incorporating InGaAsP active material, a waveguide 4 and a Bragg grating 5. The waveguide on the active (InGaAsP) material is aligned to the waveguide on the passive (SOI) material to provide good optical coupling. Reflections at the interface between the active material and the passive material are minimised. The rear facet of the optical amplifier 3 and the grating 5 act as a pair of mirrors and form a Fabry-Perot etalon having a set of allowed modes. A monitor photodiode 6 is coupled to the waveguide 4 by way of a tap-off coupler 7 so that a portion of the light transmitted along the waveguide 4 is tapped off and detected by the monitor photodiode 6 which produces an electrical feedback signal indicative of the output power. Furthermore a thermistor 8 is provided to control the temperature of the laser in known manner. The output power from the waveguide 4 is supplied to a single mode optical fibre 9 coupled to the waveguide by an optical connector 10.

Since the grating 5 has only a narrow reflection bandwidth, only the etalon modes that lie within the grating reflection peak are permitted laser modes. Furthermore the permitted mode closest to the grating reflectance peak will become the dominant laser mode. It should be noted that, for reasons associated with the optical amplifier, there is a slight tendency for the laser to operate on one side of the Bragg peak. Under certain circumstances two adjacent permitted laser modes may be approximately equidistant from the grating reflectance peak, in that each mode has the approximately the same round trip loss. When this occurs the laser becomes unstable and the dominant laser mode may suddenly change, as shown diagrammatically in the graph of the grating reflectance R against wavelength λ. In FIG. 2 the lines 11 denote the wavelengths of the allowed laser modes, and the curve 12 indicates the variation of the grating reflectance with wavelength. The arrow 14 indicates a mode hop between adjacent modes 11 causing a sudden change in wavelength of the laser output. This sudden change in wavelength is extremely undesirable, and a method is proposed for controlling the mode position such that such mode hops cannot occur.

In order to eliminate such mode hopping a control method has been proposed which is intended to align the lasing mode with the Bragg peak. This can be expressed as controlling the lasing mode so that there is either zero detuning or a controlled degree of detuning, as shown by the graph of grating reflectance R against detuning dλ shown in FIG. 3. In the figure the line 16 denotes the lasing mode which is shown aligned with the Bragg peak indicated by the broken line 17, corresponding to zero detuning of the laser. The detuning can be controlled by a phase modulator in order to maintain such zero detuning.

FIG. 4 diagrammatically shows such a laser incorporating a phase modulator 20 intermediate the optical amplifier 3 and the grating 5. Typically the phase modulator 20 is a heater through which a current is passed in order to provide local heating in the vicinity of the waveguide 4 in order to change the refractive index of a section of the waveguide and to thereby change the optical path length of the laser cavity. By controlling the phase modulation produced by the phase modulator, the detuning of the lasing mode 16 relative to the Bragg peak 17 may be reduced to zero, as shown in the graph of FIG. 5. Since the output power of the laser depends on the magnitude of the grating reflectance, the output power will also be varied as the detuning is varied, as shown by the graph of FIG. 6 of the output power P as a function of the drive current I to the optical amplifier for difference reflectance values. This graph incorporates lines 22 indicative of the output power P against drive current I for different values of grating reflectance R. The arrow 24 shows the direction of increasing reflectance for higher output power levels in the graph (the direction of increasing reflectance being in the opposite direction for lower output power levels). Furthermore, as the detuning is varied, the reflectance also varies and hence the output power is varied. As shown by the graph of the output power P against detuning dλ (difference in wavelength from the Bragg wavelength) of FIG. 7, the output power is at a minimum when the detuning is zero for values of the drive current I which are substantially greater than the threshold current Ith (solid curve 25) whereas, for values of the drive current I just greater than the threshold current Iₜₕ, the output power is at a maximum when the detuning is zero (broken curve 26).

Thus the output power P is a well-defined function of detuning dλ. For useful applications the laser drive current I is well above the threshold Iₜₕ, and as a result the output power will be at a minimum for zero detuning. Accordingly the point of zero detuning can be determined by detecting when the output power is at a minimum.

It is therefore possible to effect zero detuning by supplying a small signal modulation or dither to a control signal applied to the phase modulator in order to cause modulation of the output power, as shown diagrammatically in FIG. 8 in which the curve 25 is shown for the case in which the drive current I considerably exceeds the threshold current Iₜₕ, and the reference numeral 27 denotes the applied modulation. A phase sensitive detector can be used to measure the amplitude of the induced output modulation by a method which effectively differentiates the detuning transfer function to provide a function F which varies with detuning as shown in FIG. 9. A control circuit may then be provided to lock the output power to the point at which the function curve 28 crosses the zero detuning line 29. This approach may also be used to lock the detuning to a nominal point a small distance to either side of the zero detuning line 29. For this method to function correctly it is essential that:

1. The function F has a single crossing point of the vertical axis which is close to zero detuning.

2. The power versus detuning curve is a smooth curve with a single turning point located close to zero detuning.

3. The power versus detuning curve has sufficient curvature near to zero detuning such that the function F has a sufficiently large signal to noise ratio near zero detuning. A flat power versus detuning curve will cause the control circuit to wander close to zero detuning.

“Simple Spectral Control Technique for External Cavity Laser Transmitters”, K. R. Preston, Electronics Letters, Vol. 18, No. 25, December 1982 discloses an active mode control technique in which the output signal from a monitor photodiode monitoring the output power is supplied to a feedback control circuit in which the mean current is compared to a reference level, and a difference signal is used to control the drive current to the laser. However this control method suffers from the disadvantages that the shape of the control signal transfer characteristics changes with the laser drive current, and furthermore the shape of the control signal transfer characteristics can be very flat and noisy. This makes it difficult for the control circuit to function well.

Accordingly, in a control method in accordance with the invention, an optical feedback signal is derived from detection of the optical power P_{R} which is reflected back into the laser cavity by the grating. The optical feedback signal is supplied to a phase modulator which is caused to align the laser mode with the Bragg peak to provide zero detuning, this alignment being achieved when the optical feedback signal is at a maximum indicating maximum reflected power. The reflected optical power P_{R} varies with detuning according to a profile which remains centred on the same peak value regardless of any variation in the drive current. Such a control method therefore overcomes the above mentioned disadvantages associated with the known control methods in that the relative amount of power reflected by the grating will not be adversely affected by the drive current, and the shape of the reflection transfer function will always follow the shape of the grating reflection which does not change.

In a first embodiment of the invention shown in FIG. 10, in which like parts are denoted by the same reference numerals as in FIG. 1, a phase modulator 20 is disposed between the optical amplifier 3 and the Bragg grating 5. Typically the phase modulator 20 is in the form of a conductive heater for heating the waveguide 4 locally in the region between the optical amplifier 3 and the grating 5 in order to vary the refractive index of that region of the waveguide 4. In addition a reflection photodiode 30 is coupled to the waveguide 4 by an optical tap-off coupler 31 which taps off a proportion of the optical power reflected by the grating 5. The reflection photodiode 30 therefore provides an electrical feedback signal indicative of the power reflected by the grating 5. The optical tap-off coupler splitter 31 is preferably an evanescent coupler. However any other type of optical splitter may be used in this application instead.

The photodiode 6 provides a further feedback signal indicative of the optical power transmitted by the laser device, and a control circuit is provided to control the phase modulator 20 such that the detuning is zero, this control being effected by ensuring that the ratio of the first feedback signal (indicating the reflected power) and the second feedback signal (indicating the transmitted power) is maximised. In the event that constant transmitted output power is required, an additional control circuit may be provided to ensure that the second output signal indicative of the transmitted power is maintained constant. The bandwidth of this additional control circuit will be approximately ten times less than that of the mode control circuit, that is less than about 100 Hz.

Two alternative drive techniques may be utilised. In a first technique the device is driven so as to provide constant output power in which case the drive current supplied to the device is gradually increased until the desired output power is reached. In this case the threshold current increases as the cavity mode is moved relative to the Bragg peak, and as a result the current through the amplifier must be varied to provide the required output power. The detuning is controlled on the basis of the ratio of the reflected power (as indicated by the first feedback signal) to the transmitted power (as indicated by the second feedback signal). In an alternative technique the device is driven so as to maintain the drive current constant while the output power is varied.

In an alternative embodiment of the invention shown in FIG. 11, the transmission photodiode 6 and the reflection photodiode 30 are coupled to the waveguide 4 by means of a common evanescent coupler 41. In this case a tapped off portion of the reflected power is transmitted in one direction to the receiver photodiode 30, whereas a tapped off portion of the transmitted power (before reflection of some of the power by the grating 5) is transmitted in the opposite direction to the transmission photodiode 6. The feedback signals from the two photodiodes may be used in the same way as described with reference to FIG. 10 above to control the detuning of the device, except that compensation of the output signal from the transmission photodiode 6 is required using the output signal from the reflection photodiode 30, in order to take account of the fact that the transmission signal is detected prior to partial reflection by the grating 5.

In a further embodiment of the invention shown in FIG. 12, a curved waveguide optical amplifier 50 is used, and the Bragg grating 5 is coupled to the amplifier 50 so as to receive light transmitted from the output facet of the amplifier and so as to in turn transmit light to an output optical fibre (not shown). The amplifier 50 preferably has a waveguide which is normal to the back facet of the amplifier but which is angled at a non-normal angle to the front facet of the amplifier. A reflection photodiode 30 is coupled to the amplifier by a waveguide 51 so as to receive light reflected by the grating 5 and partially reflected at the front facet of the amplifier. As in the previously described embodiments the reflection photodiode 30 provides a feedback signal indicative of the power reflected by the grating 5, and thus indicative of the power transmitted by the laser device. This feedback signal may be used to control the detuning by adjusting the cavity length, for example by varying the temperature of the optical amplifier or the optical fibre (although this would be relatively inefficient in the case of adjustment of the fibre temperature) or by varying the relative positions of the amplifier and the fibre by less than a wavelength. Such positional adjustment could be effected by piezoelectric stages.

In a further embodiment of the invention shown in FIG. 13, an in-line semiconductor optical amplifier 60 is used, as opposed to the reflective optical amplifiers used in the other embodiments described above. As in the previously described embodiment, the Bragg grating 5 is coupled to the optical amplifier 60 so as to receive light transmitted from the output facet of the amplifier, and a reflection photodiode 30 is coupled to the amplifier by a waveguide 51 so as to receive light reflected by the grating 5 and partially reflected at the output facet of the amplifier. However, in this embodiment, a second external reflector is provided in the form of a further Bragg grating 61 coupled to the back facet of the amplifier for receiving light transmitted from the back facet of the amplifier. This embodiment otherwise operates similarly to the previously described embodiment.

It may also be advantageous in this embodiment to provide a second reflection photodiode, similar to the photodiode 30, for receiving light reflected by the grating 61 and partially reflected at the back facet of the amplifier. As a further variant a transmission photodiode, similar to the photodiode 6 shown in FIG. 10, may be provided for monitoring the power transmitted by the device, and a second transmission photodiode may be provided for monitoring the power transmitted by the second grating 61. The Bragg gratings may be replaced by sampled gratings or super structure gratings to make a tunable laser, in which case the use of such transmission photodiodes may be particularly advantageous.

FIG. 14 is a diagram indicating other embodiments of the invention utilising an optical amplifier 50 (in this case a curved waveguide optical amplifier), a Bragg grating 5 and one or more of the photodiodes 6, 30 and 70. Embodiments using a reflection photodiode 30, and optionally also a transmission photodiode 6, have already been described. However it should be appreciated that the invention could also be implemented using a back-reflection photodiode 70 for monitoring the light transmitted from the back facet of the amplifier in order to provide a feedback control signal indicative of the power reflected by the grating 5 which may be used to control the detuning, preferably in association with a signal from a transmission photodiode 6 indicative of the power transmitted by the device. Whether such a back-reflection photodiode 70 is used or a reflection photodiode 30, the use of a transmission photodiode 6 may be dispensed with in the event that a calibration table is provided containing laser calibration information, and details are also available of the drive current/bias/pump energy into the amplifier.

The invention is also applicable to a number of other possible geometries, and moreover can be applied to any design of external cavity laser, whether of monolithic or hybrid construction, including gas lasers and fibre lasers. In the case of a monolithic DBR laser construction in accordance with the invention, it should be appreciated that the gain section, the phase modulation section and the grating section are all fabricated on a single substrate so that these sections could all be considered as being internal to the cavity of the device (rather than as being external to the cavity as described above). It would also be possible for the or each photodiode to be included on the same substrate.

1. A laser system comprising an input waveguide for receiving an optical input signal from an optical amplifier, partial reflecting means for receiving the optical input signal from the input waveguide and for reflecting a portion of the optical input signal back along the input waveguide to define a resonant cavity with the optical amplifier, reflection photodetector means for detecting light reflected back by the partial reflecting means and for supplying an electrical output signal indicative of the reflected light, phase modulation means for modulating the phase of the optical input signal, and control means for controlling the phase modulation means in dependence on the electrical output signal from the reflection photodetector means in order to provide a stabilised optical output signal.

2. A laser system according to claim 1, wherein the reflection photodetector means comprises a back facet photodetector for detecting light transmitted from the back facet of the optical amplifier and for supplying an electrical output signal indicative of the detected light.

3. A laser system according to claim 1, wherein the reflection photodetector means comprises a detection waveguide optically coupled to the input waveguide to receive a proportion of the light reflected by the partial reflecting means, and a photodetector for detecting the signal received by the detection waveguide.

4. A laser system according to claim 3, wherein the detection waveguide is optically coupled to the input waveguide by an evanescent coupler.

5. A laser system according to any preceding claim, wherein transmission photodetector means is provided for detecting the optical output signal and for supplying an electrical output signal indicative of the optical output signal.

6. A laser system according to claim 5, wherein the transmission photodetector means comprises a transmission waveguide optically coupled to an output waveguide along which the optical output signal is transmitted to receive a proportion of the output signal, and a photodetector for detecting the signal received by the transmission waveguide.

7. A laser system according to claim 4 when appended directly or indirectly to claim 2, wherein the transmission photodetector means comprises a transmission waveguide integral with the reception waveguide with both the transmission and reception waveguides being optically coupled to the input waveguide by a common optical coupler to receive proportions of both the input signal and the reflected light, and a photodetector for detecting a proportion of the input signal received by the transmission waveguide.

7. A laser system according to any preceding claim, wherein the partial reflecting means incorporates a Bragg grating.

8. A laser system according to any preceding claim, wherein the control means is arranged to control the phase modulation means so as to ensure zero detuning between the mode of the optical output signal and the peak reflection of the partial reflecting means.

9. A laser system according to any preceding claim, wherein the control means is arranged to control the phase modulation means in dependence on the power of the reflected signal portion as determined from the electrical output signal of the reflection photodetector means.

10. A laser system according to any preceding claim, wherein the control means is arranged to control the phase modulation means in dependence on the ratio of the power of the reflected light and the power of the optical output signal.

11. A laser system according to any preceding claim, wherein the control means is arranged to control the phase modulation means by applying dither modulation to the input signal and detecting the amplitude of the induced output modulation resulting from the application of such dither modulation.

12. A laser system according to any preceding claim, wherein the phase modulation means comprises a heater for locally heating a section of the input waveguide to change the refractive index of said section.

13. A laser system according to any preceding claim, further comprising an optical amplifier coupled to the input waveguide and constituting a laser source.

14. A laser system substantially as hereinbefore described with reference to FIGS. 2 to 14 of the accompanying drawings.
